(19) United States
(12) Patent Application Publication
(10) Pub. No.: US 2012/0278847 A1
(43) Pub. Date: Nov. 1, 2012

(54) ELECTRONIC APPARATUS AND IMAGE PROCESSING METHOD

(76) Inventor: Hidetoshi Yokoi, Ome-shi (JP)

(21) Appl. No.: 13/397,385

(22) Filed: Feb. 15, 2012

(30) Foreign Application Priority Data
Apr. 28, 2011 (JP) 2011-102280

(51) Int. Cl. H04N 7/173

(52) U.S. Cl. 725/116

(57) ABSTRACT

According to one embodiment, an electronic apparatus includes a receiving module, a moving image generation module, a clock module which measures a date, and a transmission module. The receiving module receives date information, which indicates a particular date of a user of a user terminal and includes a first image related to the user of the user terminal, from the user terminal via a network. The moving image generation module extracts a first still image group related to the first image in the date information from a plurality of still images, and generates a first moving image using the extracted first still image group. The transmission module transmits the first moving image to the user terminal via the network when a date indicated by the clock module reaches a date corresponding to the particular date of the user of the user terminal.

### CROSS-REFERENCE TO RELATED APPLICATIONS

This application is based upon and claims the benefit of priority from prior Japanese Patent Application No. 2011-102280, filed Apr. 28, 2011, the entire contents of which are incorporated herein by reference.

### FIELD

Embodiments described herein relate generally to an electronic apparatus which displays an image, an image processing method, and a program.

### BACKGROUND

In recent years, a moving image generation technique which generates a moving image (for example, a photomovie, slideshow, etc.) using still images such as photos has received a lot of attention. As the moving image generation technique, a technique for generating a moving image using still images stored in a directory designated by the user is known.

Also, recently, an automatic data transmission technique for automatically transmitting specific data (a message, still image, music data, etc.) from an electronic apparatus of the user to that of another user on a date such as an anniversary, which is set in advance, has received a lot of attention.

However, in order to transmit data to the electronic apparatus of the other user on the anniversary of that user, the user who transmits the data has to register the anniversary of that user in his or her electronic apparatus in advance. Furthermore, the user who transmits the data has to prepare in advance for data (a message, still image, music data, etc.) to be transmitted to the other user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment;

FIG. 2 is an exemplary block diagram showing the system arrangement of the electronic apparatus according to the embodiment;

FIG. 3 is an exemplary view showing the overall configuration of a network to which the electronic apparatus according to the embodiment is connected;

FIG. 4 is an exemplary view showing an example of anniversary moving image generation processing executed by the electronic apparatus according to the embodiment;

FIG. 5 is an exemplary view for explaining examples of anniversary information receiving processing and anniversary moving image transmission processing executed by the electronic apparatus according to the embodiment;

FIG. 6 is an exemplary block diagram showing an example of the arrangement of a photomovie generation application program executed by the electronic apparatus according to the embodiment;

FIG. 7 shows an example of a group setting database table used by the electronic apparatus according to the embodiment;

FIG. 8 shows an example of an anniversary setting database table used by the electronic apparatus according to the embodiment;

FIG. 9 shows an example of an index information database table used by the electronic apparatus according to the embodiment;

FIG. 10 is an exemplary flowchart showing an example of the sequence of anniversary setting processing executed by the electronic apparatus according to the embodiment;

FIG. 11 shows an example of a group setting screen displayed by the electronic apparatus according to the embodiment;

FIG. 12 shows an example of a group anniversary setting screen displayed by the electronic apparatus according to the embodiment;

FIG. 13 shows an example of a group/user information edit screen displayed by the electronic apparatus according to the embodiment;

FIG. 14 is an exemplary flowchart showing an example of the sequence of image data generation processing executed by the electronic apparatus according to the embodiment; and

FIG. 15 is an exemplary flowchart showing an example of the sequence of moving image receiving processing executed by the electronic apparatus according to the embodiment.

### DETAILED DESCRIPTION

Various embodiments will be described hereinafter with reference to the accompanying drawings.

In general, according to one embodiment, an electronic apparatus includes a receiving module, a moving image generation module, a clock module which measures a date, and a transmission module. The receiving module receives, from a user terminal via a network, date information which indicates a particular date of a user of the user terminal and includes a first image related to the user of the user terminal. The moving image generation module extracts a first still image group related to the first image in the date information from a plurality of still images, and generates a first moving image using the extracted first still image group. The transmission module transmits the first moving image to the user terminal via the network when the date indicated by the clock module is a date corresponding to the particular date of the user of the user terminal.

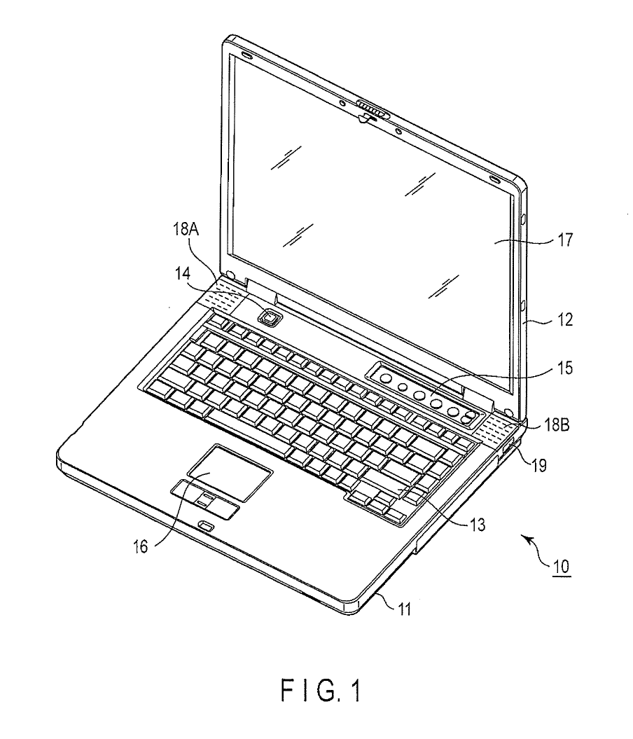

FIG. 1 is a perspective view showing the outer appearance of an electronic apparatus according to an embodiment. This electronic apparatus is implemented as, for example, a notebook type personal computer 10. As shown in FIG. 1, the computer 10 is configured by a computer main body 11 and display unit 12. An LCD (Liquid Crystal Display) 17 is built in the display unit 12. The display unit 12 is mounted on the computer main body 11 to be rotatable between an open position where the upper surface of the computer main body 11 is exposed, and a close position where the upper surface of the computer main body 11 is covered.

The computer main body 11 has a low-profile box-shaped housing. A keyboard 13, a power button 14 used to turn on/off a power supply of the computer 10, an input operation panel 15, a touch pad 16, loudspeakers 18A and 18B, and the like are arranged on the upper surface of the computer main body 11. On the input operation panel 15, various operation buttons are arranged. On the right side surface of the computer main body 11, a USB connector 19 used to connect a USB cable and USB device is arranged.

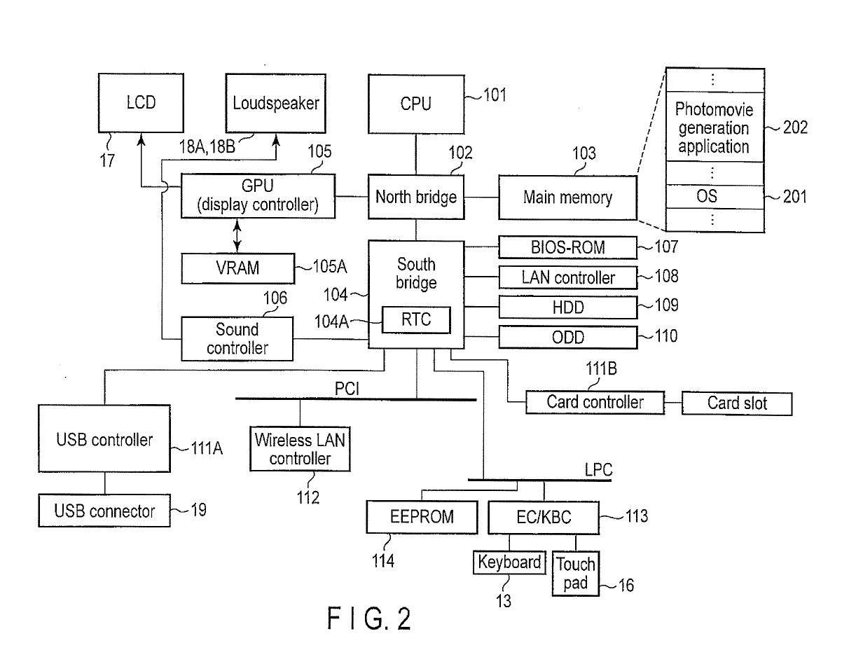

FIG. 2 shows the system arrangement of the computer 10.

As shown in FIG. 2, the computer 10 includes a central processing unit (CPU) 101, north bridge 102, main memory 103, south bridge 104, real-time clock (RTC) 104A, graphics processing unit (GPU) 105, video random access memory (VRAM) 105A, sound controller 106, Basic Input/Output System read-only memory (BIOS-ROM) 107, local area network (LAN) controller 108, hard disk drive (HDD) 109, optical disk drive (ODD) 110, USB controller 111A, card controller 111B, wireless LAN controller 112, embedded controller/keyboard controller (EC/KBC) 113, electrically erasable programmable ROM (EEPROM) 114, and the like.

The CPU 101 is a processor which controls the operations of the respective units in the computer 10. The CPU 101 executes an operating system (OS) 201 and various application programs such as a photomovie generation application program 202, which are loaded from the HDD 109 onto the main memory 103. The photomovie generation application program 202 is software used to play back various digital content data (for example, photomovies). These digital content data are stored in, for example, the HDD 109. This photomovie generation application program 202 has a moving image generation function. This moving image generation function generates a moving image (composite movie) using a digital content stored in, for example, the HDD 109. Furthermore, this moving image generation function includes a function of analyzing the content used in the moving image. The photomovie generation application program 202 plays back the moving image generated using the content, and displays the moving image on a screen (LCD 17).

Furthermore, the photomovie generation application program 202 has a function of automatically generating moving image data on an anniversary of a certain user, who is registered in advance, and transmitting that moving image data to a user terminal of that user.

The CPU 101 also executes a BIOS stored in the BIOS-ROM 107. The BIOS is a program required for hardware control.

The north bridge 102 is a bridge device which connects a local bus of the CPU 101 and the south bridge 104. The north bridge 102 incorporates a memory controller which controls accesses to the main memory 103. Also, the north bridge 102 has a function of executing a communication with the GPU 105 via, for example, a serial bus compliant with the PCI EXPRESS (registered trademark) specification.

The GPU 105 is a display controller which controls the LCD 17 used as a display monitor of the computer 10. A display signal generated by this GPU 105 is sent to the LCD 17.

The south bridge 104 controls respective devices on a Peripheral Component Interconnect (PCI) bus and respective devices on a Low Pin Count (LPC) bus. The south bridge 104 incorporates an Integrated Drive Electronics (IDE) controller required to control the HDD 109 and ODD 110, and the RTC 104A. Furthermore, the south bridge 104 has a function of executing a communication with the sound controller 106.

The RTC 104A is a clock module which measures a date and time. The photomovie generation application program 202 can determine based on the date indicated by the RTC 104A whether or not the current date is an anniversary of a user.

The sound controller 106 is a sound source device, and outputs audio data to be played back to the loudspeakers 18A and 18B. The LAN controller 108 is a wired communication device which executes a wired communication of, for example, the IEEE 802.3 specification. On the other hand, the wireless LAN controller 112 is a wireless communication device which executes a wireless communication of, for example, the IEEE 802.11g specification. The USB controller 111A executes a communication with an external apparatus compatible with, for example, the USB 2.0 specification. For example, the USB controller 111A is used to receive image data files stored in a digital camera. The card controller 111B executes data read and write accesses to a memory card such as an SD card inserted in a card slot provided to the computer main body 11.

The EC/KBC 113 is a one-chip microcomputer, which integrates an embedded controller for power management, and a keyboard controller required to control the keyboard 13 and touch pad 16. The EC/KBC 113 has a function of turning on/off the power supply of the computer 10 in response to an operation of the power button 14 by the user.

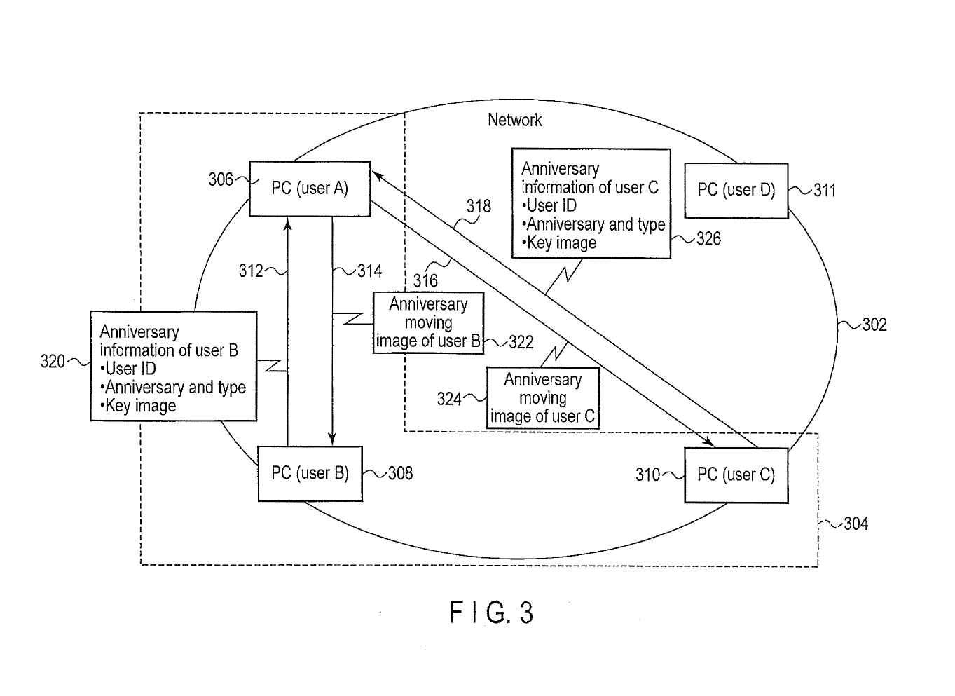

A system in which the aforementioned electronic apparatuses exchange data via a network will be described below with reference to FIG. 3. FIG. 3 shows an example of the configuration of a network to which a plurality of user terminals such as computers are connected.

A network 302 can be that to which a plurality of user terminals can be connected. For example, the network may be the Internet, a LAN, or a near field network such as Bluetooth® without the intervention of any router or server. Furthermore, each user terminal need not always be connected to the network.

FIG. 3 exemplifies personal computers (PCs) as the user terminals. Of course, the present embodiment is not limited to the PCs, and personal digital assistants (PDAs), smartphones, and the like may be used as the user terminals.

As shown in FIG. 3, PCs 306, 308, 310, and 311 are connected to the network 302. These PCs 306, 308, 310, and 311 are user terminals of users A, B, C, and D, respectively. Each of the PCs 306 308, 310, and 311 have correspond to the computer 10 of this embodiment, and have the same functions as the computer 10 of this embodiment. In other words, the aforementioned photomovie generation application program 202 is installed in the PCs 306, 308, 310, and 311.

The photomovie generation application program 202 has a function of setting a group (to be also referred to as a user group hereinafter). The group includes a plurality of users. FIG. 3 shows a group 304 including user A of the PC 306, user B of the PC 308, and user C of the PC 310. FIG. 3 shows the group 304 including the three users, but a group may include, for example, two users like users A and B. Also, a user terminal of a user who does not belong to the group 304 like the PC 311 may be connected to the network 302. Such user group can be arbitrarily set by the user of each user terminal. For example, user A can set the group 304 including users A, B, and C. Also, user A can set another user group including, for example, users A and B.

Next, data exchange process for the user terminals connected to each other thorough the network 302 as shown in FIG. 3 will be described below. The data include pieces of anniversary information 320 and 326, and moving image data (anniversary moving images) 322 and 324. Each of the pieces of anniversary information 320 and 326 is information associated with anniversaries of users of the user terminals. Each of the pieces of anniversary information 320 and 326 indicates an anniversary of the corresponding user, and includes a key image related to the corresponding user. More specifically, each of the pieces of anniversary information 320 and 326 is information which includes a user ID, an anniversary, the type of that anniversary, and a key image. Each of the pieces of anniversary information 320 and 326 may include information indicating an anniversary name.

An example of the anniversary information 320 of user B of the PC 308 will be described below. In this case, assume that user B sets his or her birthday as an anniversary. The anniversary information 320 includes a user ID (for example, a character string “0002” or a nickname) as an ID unique to user B. Furthermore, the anniversary information 320 includes information indicating the birthday of user B. Moreover, the anniversary information 320 includes information indicating a type (for example, if a birthday belongs to a category “happy”, the type is “happy”) to which the anniversary (birthday) of user B belongs. In addition, the anniversary information 320 includes a key image related to user B. The key image related to user B includes, for example, a head shot of user B or a photograph taken on the birthday of user B. In this sense, the key image is an image which is related to the anniversary of user B. The key image may include, for example, a photograph possessed by user B or a photograph that obtained by capturing an image of an object closely related to user B.

Next, the moving image data (anniversary moving images) 322 and 324 will be described below. Each of the moving image data 322 and 324 is a photomovie or slideshow, which is generated by the photomovie generation application program 202 based on the aforementioned key image. The moving image data generation method will be described later.

The data including such anniversary information and moving image data are exchanged between the user terminals. How to exchange data between the user terminals in practice will be described below with reference to FIG. 3.

The PC 306 of user A receives, from the PC 308 via a route 312, the anniversary information 320 of user B who belongs to the group 304. Likewise, the PC 306 of user A receives, from the PC 310 via a route 318, the anniversary information 326 of user C who belongs to the group 304. Based on the anniversary information 320 of user B, the photomovie generation application program 202 of the PC 306 generates the moving image data 322 related to user B. For example, on a date corresponding to the anniversary of user B such as the anniversary of user B or several dates before and after that anniversary, the photomovie generation application program 202 of the PC 306 extracts still images related to the key image included in the anniversary information 320 of user B from a plurality of still images saved in the PC 306. The photomovie generation application program 202 generates moving image data (photomovie or slideshow) using the extracted still images, and transmits that moving image data to the PC 308 of user B. In this case, since the photomovie or slideshow need only be transmitted to the PC 308 on a date corresponding to the anniversary of user B, the photomovie or slideshow related to user B may be generated before the date corresponding to the anniversary of user B.

Furthermore, the photomovie generation application program 202 can set anniversary information related to the group 304. The anniversary information related to the group 304 includes an anniversary of the group 304, a type of that anniversary, and a key image related to the group 309. For example, the anniversary of the group 304 can be an anniversary such as a wedding anniversary or an n-th anniversary of an event common to a plurality of users included in the group. As the type of the anniversary, for example, when that anniversary belongs to a category “happy”, the type is “happy”. The key image related to the group 304 is, for example, a photograph which was taken on the anniversary and a photograph in which some users who belong to the group 304 appear. In this way, user A sets the anniversary information related to the group 304. Then, on a date corresponding to the anniversary related to the group 304, the photomovie generation application program 202 of the PC 306 generates moving image data such as a photomovie or slideshow related to the group 304 based on the key image of the group 304. The photomovie generation application program 202 transmits that moving image data to the PCs 308 and 310 as the user terminals of users B and C who belong to the group 304 on the date corresponding to the anniversary related to the group 304.

In this manner, the photomovie generation application program 202 receives anniversary information from the user terminal of the user who is registered in advance by executing a communication with that user terminal. Then, the photomovie generation application program 202 generates moving image data (anniversary moving image) based on a key image included in the received anniversary information, and transmits that moving image data to the user terminal of the user who is registered in advance. Hence, user A of the PC 306 need not make operations required to input the anniversaries of users B and C, to select key images respectively related to users B and C, and so forth. Hence, a given user can provide moving image data (anniversary moving image) to the remaining users in the group by a simple operation.

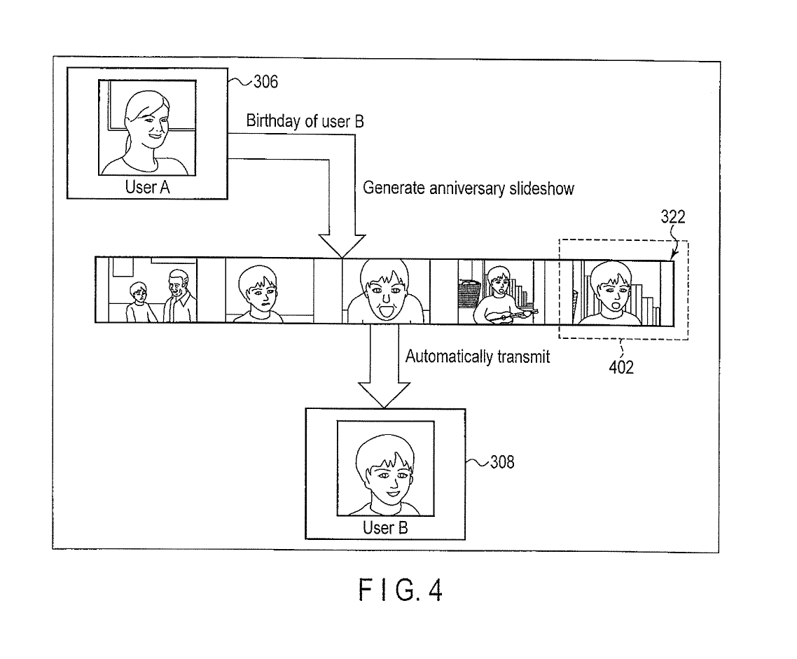

FIG. 4 shows an overview of the anniversary moving image generation processing executed by the electronic apparatus 10. In this case, assume that the anniversary of user B is the birthday of user B. On the birthday of user B, the photomovie generation application program 202 of the PC 306 of user A extracts still images related to the key image of user B from a plurality of still images stored in the PC 306. The photomovie generation application program 202 of the PC 306 of user A generates a slideshow 322 as an anniversary moving image related to the anniversary of user B using the extracted still images. The slideshow 322 includes, for example, still images in which a face image of user B appears. The key image may be used as an image 402 to be displayed lattermost in the slideshow 322. Also, the key image may be inserted at the head position or in the middle of the slideshow 322. The generated slideshow 322 is automatically transmitted to the PC 308 of user B on the anniversary of user B by the photomovie generation application program 202 of the PC 306 of user A. The slideshow 322 transmitted from the PC 306 is received by the PC 308 of user B. The PC 308 plays back the received slideshow 322.

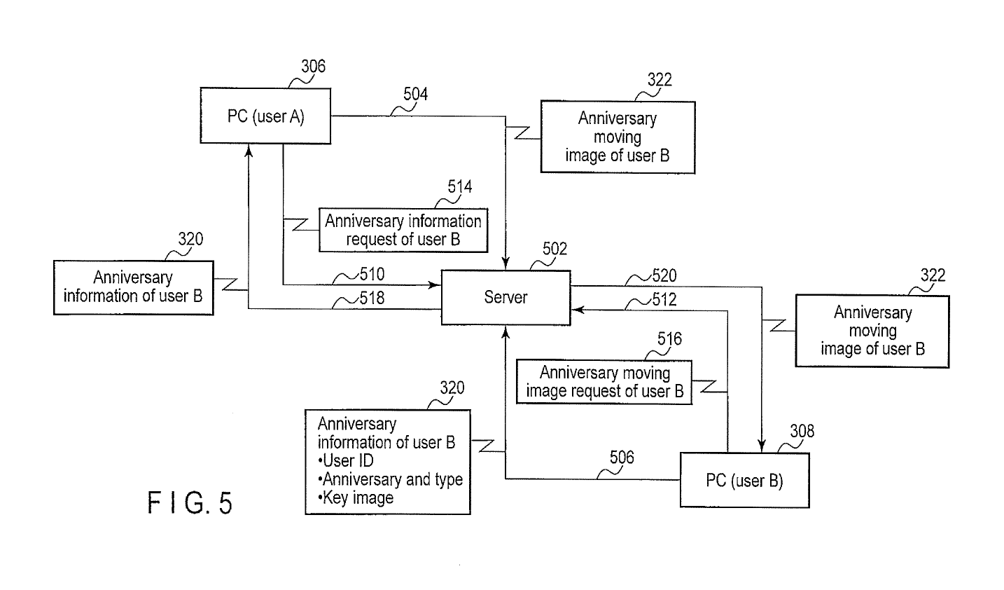

In this way, the moving image data 322 and 324 are exchanged between the user terminals via the network 302. As a communication form via the network 302, a form in which a plurality of user terminals are directly connected via the network 302, as shown in FIG. 3, may be used. Also, as another communication form via the network 302, a form in which a plurality of user terminals are connected via a server 502, as shown in FIG. 5, may be used.

The data exchange processes via the server 502 will be described below with reference to FIG. 5. In this case, a case will be assumed wherein the PC 306 of user A transmits the moving image data 322 to the PC 308 of user B on the anniversary of user B, as in FIG. 3.

Initially, the PC 308 of user B transmits the anniversary information 320 of user B to the server 502. Next, the PC 306 of user A sends a request 514 for an anniversary information of user B to the server 502 via a route 510, so as to acquire the anniversary information 320 of user B. The server 502 transmits the anniversary information 320 of user B transmitted from the PC 308 of user B to the PC 306 of user A via a route 518 in response to the request 514 for the anniversary information of user B. The PC 306 of user A receives the anniversary information 320 of user B. The PC 306 of user A generates the moving image data 322 based on the received anniversary information 320 of user B, as in the case of FIG. 3. Then, the PC 306 of user A transmits that moving image data 322 to the server 502 via a route 504 on a date corresponding to the anniversary of user B. Also, the PC 306 of user A requests the server 502 to transmit the moving image data 322 to the PC 308 of user B. The server 502 transmits the moving image data 322 received from the PC 306 of user A to the PC 308 of user B via a route 520.

In response to an anniversary information request from an arbitrary user terminal, the server 502 transmits anniversary information to the user terminal which issues the request. For example, when the server 502 receives anniversary information, it may immediately transmit that anniversary information to user terminals connected to the server 502 without any anniversary information requests from user terminals. In FIG. 5, data are exchanged using only one server 502. Instead, two servers may be used. These two servers may be different servers such as a server which exchanges the anniversary information 320 and that which exchanges the moving image data 322.

In this manner, in response to an anniversary information request from each user terminal to the server 502, the server 502 transmits the anniversary information requested by that user terminal to the user terminal which issues the request. In this manner, even when user terminals are not directly connected, the same effects as in FIG. 3 can be obtained. Unlike in FIG. 3, the user terminals are connected via the server in FIG. 5. For this reason, each user terminal need not always be connected to the network 302. Therefore, upon transmission the anniversary information or moving image data as in FIG. 3, even when the user terminal which is to receive that data is not connected to the network 302, the anniversary information or moving image data can be transmitted.

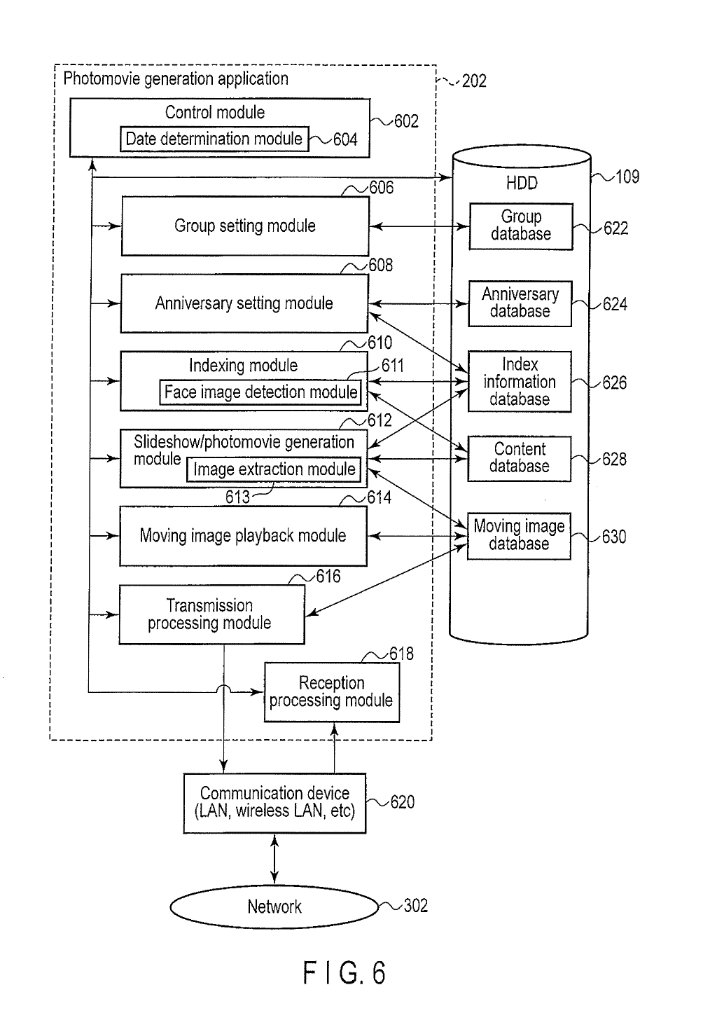

The data exchange processes between the user terminal as the electronic apparatus 10 shown in FIG. 1 and another user terminal having functions equivalent to those of the electronic apparatus 10 have been described. The detailed operation of the photomovie generation application program 202 which runs on the electronic apparatus 10 will be described below with reference to FIG. 6.

As shown in FIG. 6, the photomovie generation application program 202 is configured by a control module 602 including a date determination module 604, a group setting module 606, an anniversary setting module 608, an indexing module 610 including a face image detection module 611, a slideshow/photomovie generation module 612 including an image extraction module 613, a moving image playback module 614, a transmission processing module 616, and a reception processing module 618. The HDD 109 stores a group database 622, anniversary database 624, index information database 626, content database 628, and moving image database 630.

The control module 602 is bidirectionally connected to the group setting module 606, anniversary setting module 608, indexing module 610, slideshow/photomovie generation module 612, moving image playback module 614, transmission processing module 616, and reception processing module 618. Also, the control module 602 is bidirectionally connected to the HDD 109. The date determination module 604 determines, for example, whether or not the current date (note that the current date is that indicated by, for example, the RTC 104A; the same applies to the current date to be described below) matches an anniversary, and whether or not the current date is a date corresponding to the anniversary. The control module 602 controls the operations of the group setting module 606, anniversary setting module 608, indexing module 610, slideshow/photomovie generation module 612, moving image playback module 614, transmission processing module 616, reception processing module 618, and HDD 109 in accordance with the determination result of the date determination module 604.

The group setting module 606 sets the aforementioned group (user group) according to a user's operation. Also, the group setting module 606 may associate a key image (group key image) related to the set group with that group according to a user's operation. For example, when user A in FIG. 3 wants to set a group, the group setting module 606 displays a group setting screen on the LCD 17 in accordance with an operation of the input device such as the keyboard 13 by user A. Details of the group setting screen will be described later. User A inputs, for example, a name of the group, and names and IDs of users to be registered in that group on the group setting screen. The group setting module 606 records the input group related data (to be referred to as group data hereinafter) in the group database 622 in the HDD 109. When user A wants to edit the already registered group data, the group setting module 606 reads the group data from the group database 622, and displays a group data setting/edit screen on the LCD 17.

The anniversary setting module 608 sets an anniversary of a user or group. For example, when user B sets an anniversary of user B, the anniversary setting module 608 displays an anniversary registration screen on the LCD 17 according to an input signal from user B. User B inputs an ID, an date of anniversary, and the like included in the aforementioned anniversary information. The anniversary setting module 608 records the anniversary information input by user B in the anniversary database 624. Likewise, a case will be assumed wherein, for example, user B sets an anniversary related to the aforementioned group in association with the setting of the group anniversary. In this case, although details will be described later with reference to FIG. 12, the anniversary setting module 608 displays an anniversary setting screen related to a group on the LCD 17. Then, the anniversary setting module 608 records anniversary information related to the group input by user B in the anniversary database 624. As in the group setting module 606, when the user wants to edit the anniversary information already stored in the anniversary database 624, the anniversary setting module 608 reads that anniversary information from the anniversary database 624, and displays the read anniversary information on the LCD 17.

The indexing module 610 generates index information indicating attributes of each of a plurality of still images including a key image related to a user or group. The face image detection module 611 analyzes features of a still image to be indexed. The face image detection module 611 detects a face image by searching for a region having a feature similar to face image feature samples, which are prepared in advance. The face image feature samples are feature data obtained by statistically processing face image features of a large number of persons. Face detection processing detects a region corresponding to a face image included in a still image, and also detects a position (coordinates) and size of that region. The face image detection module 611 analyzes the detected face image. The face image detection module 611 calculates, for example, a degree of smile, degree of sharpness, and degree of full face of the detected face image. The degree of smile is an index indicating what degree the detected face image smiles. The degree of sharpness is an index indicating what degree the detected face image is sharp (for example, what degree that image is free from a blur). The degree of full face is an index indicating what degree the detected face image faces front.

The indexing module 610 applies clustering processing to the detected face images to classify the detected face images for respective persons. The indexing module 610 assigns identification information (person ID) of a person corresponding to each face image based on the processing result.

Based on these indices and identification information, the indexing module 610 generates index information. The generated index information is recorded in the index information database 626 and content database 628. The content database 628 stores the still images to be indexed. The still images may store a folder (photograph folder; not shown) in the HDD 109. Also, the photomovie generation application program 202 monitors the folder. Then, when the photomovie generation application program 202 detects that one or more new still images (photographic files) are stored in the photograph folder, it indexes these one or more new still images. The anniversary setting module 608 uses the index information stored in the index information database 626. Then, the anniversary of a user or group set by the anniversary setting module 608 is associated with a key image and a person who appears in the key image.

The slideshow/photomovie generation module 612 generates the aforementioned moving image data. The image extraction module 613 extracts, based on a key image, still images related to the key image of a user or group from a plurality of still images. For example, related images are extracted based on one key image related to the user. That is, still images related to the key image are automatically extracted, and moving image data is generated using the extracted still images. As generation conditions of a photomovie, a style, music, and person (face) of interest can be selected and designated. According to the selected style, a still image extraction method to be used, effects/transitions to be used, and the like are decided. The photomovie generation application program 202 automatically extracts still images to be used from all still images in the photograph folder. In the extraction processing, better photos may be extracted according to the degrees of smile, degrees of sharpness, and the like of face images. A person corresponding to each face image may be recognized and, for example, still images which include face images of the selected person, those which include face images of another person related to the selected person, and the like may be extracted. The slideshow/photomovie generation module 612 generates moving image data based on images extracted by the image extraction module 613.

The slideshow/photomovie generation module 612 generates moving image data (photomovie or slideshow) using a plurality of still images stored in the content database 628 in the HDD 109. The still images include, for example, various still image files (JPEG files) such as digital photos. A term “photomovie” means a moving image (movie) generated using a plurality of still images (for example, photos). The “photomovie” is also called “intelligent slideshow”. A term “slideshow” means a moving image (movie) in which still images is sequentially displayed one by one. The slideshow/photomovie generation module 612 reads the index information from the index information database 626, and generates moving image data based on the index information. The moving image data generated by the slideshow/photomovie generation module 612 is recorded in the moving image database 630. Also, at the time of generation of moving image data, moving image data stored in the moving image database 630 may be used in addition to still images and the like stored in the content database 628.

In the moving image generation processing, the slideshow/photomovie generation module 612 generates scenario information, which specifies an order of effects (effect sequence) and attributes of still images (still image attributes), which are to be used in a plurality of chapters (scenes) in the sequence of that moving image data. Then, the slideshow/photomovie generation module 612 generates moving image data including still images to which effects have been applied according to that scenario information.

The moving image playback module 614 plays back moving image data stored in the moving image database 630. The moving image data is played back together with music data contained in that moving image data.

The transmission processing module 616 communicates with the user terminal or server 502 on the network 302 using a communication device 620 such as a LAN controlled by the LAN controller 108 or a wireless LAN controlled by the wireless LAN controller 112. According to an instruction from the control module 602, the transmission processing module 616 transmits moving image data stored in the moving image database 630 to the user terminal via the communication device 620 and network 302.

Also, the reception processing module 618 communicates with the user terminal or server 502 on the network 302 using the communication device 620. The reception processing module 618 receives moving image data transmitted from the user terminal connected to the network 302. The reception processing module 618 sends the received moving image data to the moving image playback module 614 according to an instruction of the control module 602. The moving image playback module 614 plays back the moving image data sent from the reception processing module 618. The played moving image data is recorded in the moving image database 630. Furthermore, the reception processing module 618 receives anniversary information of each user terminal in the group from the user terminal or server 502 on the network 302 using the communication device 620 according to an instruction from the control module 602.

Finally, the processing operation of the control module 602 at the time of transmission and reception of moving image data will be described below.

When moving image data is transmitted, the date determination module 604 determines based on the anniversary information in the anniversary database 624 included in the HDD 109 whether or not the current date is an anniversary. When it is determined that the current date is an anniversary, the control module 602 may instruct the transmission processing module 616 to transmit moving image data which is related to that anniversary, is generated in advance, and is stored in the moving image database 630, to a user related to that anniversary. Alternatively, when moving image data related to the anniversary is not generated in advance, the control module 602 may instruct the slideshow/photomovie generation module 612 to generate moving image data related to the anniversary. The control module 602 may instruct the transmission processing module 616 to transmit the moving image data generated by the slideshow/photomovie generation module 612 according to that instruction to a user related to the anniversary.

A case will be assumed wherein an anniversary determined by the date determination module 604 is that related to the group. In this case, the control module 602 may instruct the transmission processing module 616 to transmit moving image data to respective users included in the group based on the group data stored in the group database 622.

When moving image data is received, the control module 602 may instruct the reception processing module 618 to receive the moving image data. For example, the control module 602 may instruct the reception processing module 618 to receive moving image data at given time intervals.

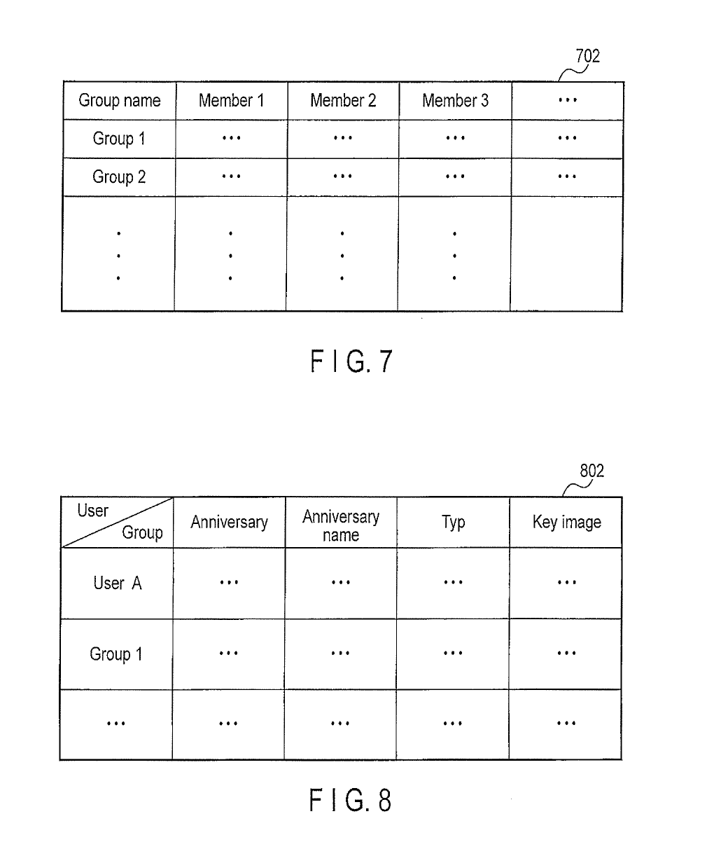

Respective data stored in the group database 622, anniversary database 624, and index information database 626 included in the HDD 109 will be described below with reference to FIGS. 7, 8, and 9.

FIG. 7 shows an example of a group database table which configures the group database 622. A group database table 702 includes a plurality of entries respectively corresponding to a plurality of groups. Each entry includes, for example, a plurality of fields such as a “member 1” field, “member 2” field, and “member 3” field. Each member field indicates a user ID of a member included in a predetermined group. More specifically, for example, if group 1 includes users A and B, one of user IDs of users A and B is stored in the “member 1” field. If the user ID of user A is stored in the “member 1” field, the user ID of user B is stored in the “member 2” field. In practice, each member field need only store information that can specify each user (for example, a name of a user [user A]). As the group names shown in FIG. 7, for example, a group name related to an anniversary (“the first birthday of user B”, and the like) may be used in addition to “group 1” and “group 2” shown in FIG. 7.

FIG. 8 shows an example of an anniversary database table which configures the anniversary database 624. An anniversary database table 802 includes a plurality of entries corresponding to users or groups. Each entry includes an “anniversary” field, “anniversary name” field, “type” field, “key image” field, and the like. The “anniversary” field indicates, for example, a date of an anniversary related to a user or group. In place of a date, the “anniversary” field may store information that can specify a date and time of an anniversary (for example, this field may include a date of an anniversary and also a time of an anniversary). The “anniversary name” field indicates a unique name related to an anniversary (for example, “birthday of user B” and “family vacations”). The “type” field indicates a type of an anniversary such as “birthday” and “wedding anniversary”. As a type of an anniversary, for example, a keyword which expresses an atmosphere of an anniversary such as “happy” and “fantasy” may be used.

The “key image” field indicates an identifier of a key image related to a user or group (for example, a file name of that key image), as has been described above with reference to FIG. 3. The identifier of the key image is set in the “key image” field in an entry corresponding to a user or group when that user or group is set. Note that this key image may be, for example, that of user B included in anniversary information transmitted from user B to user A. Alternatively, the key image may be that after user A edits the key image of the anniversary information received from user B.

Respective values of the “anniversary”, “anniversary name”, “type”, and “key image” fields corresponding to a certain user may be automatically set based on anniversary information received from the user terminal of that user. For example, a case will be assumed wherein group 1 including users A and B as members is to be set. In this case, the photomovie generation application program 202 requests the server 502 to transmit anniversary information of user B based on the user ID of user B input to the group database 622. As a result, the photomovie generation application program 202 receives the anniversary information of user B from the user terminal of user B via the server 502. Of course, when, for example, an IP address of the user terminal of user B is given, the photomovie generation application program 202 may receive the anniversary information of user B from the user terminal of user B by directly communicating with the user terminal of user B. An anniversary, anniversary name, and type included in the anniversary information of user B are respectively automatically set in the “anniversary”, “anniversary name”, and “type” fields in an entry of user B. Also, a key image (key image file) included in the anniversary information of user B is stored in the content database 628, and a file name of that key image (key image file) is automatically set in the “key image” field in the entry corresponding to user B.

The anniversary database table 802 is a table of a database of anniversary information related to users and groups. That is, anniversary information related to each user and that related to each group are stored in the anniversary database 624 as a single database. However, a database related to only anniversary information of users or that related to groups may be stored in the anniversary database 624 as an independent database.

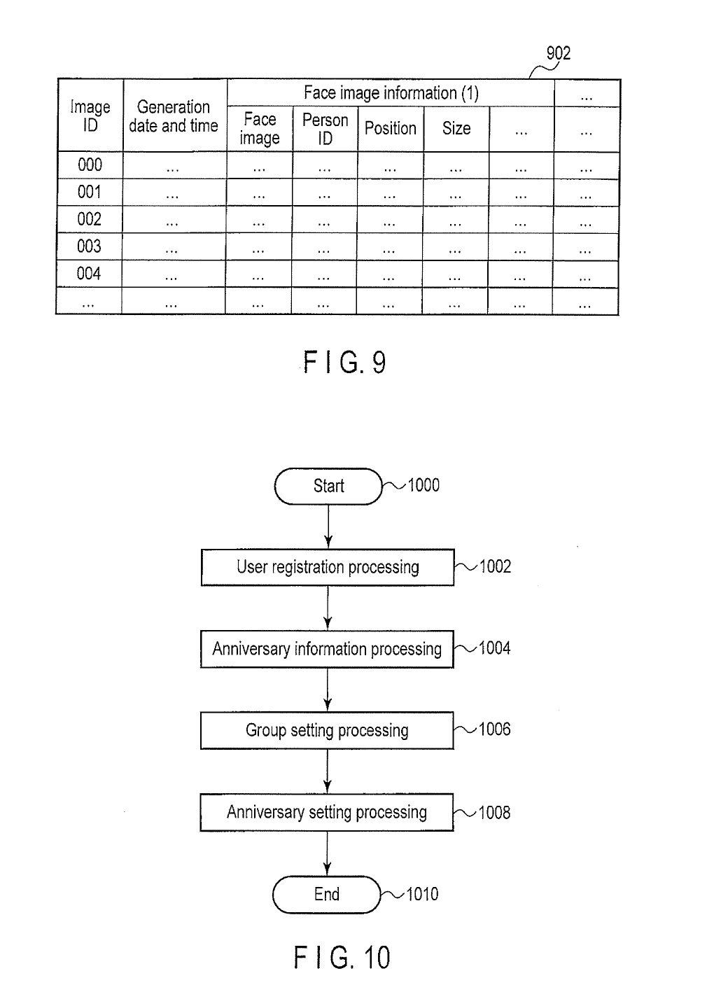

FIG. 9 shows an example of an index information database table which configures the index information database 626. An index information database table 902 includes a plurality of entries respectively corresponding to a plurality of still images. Each entry includes, for example, fields respectively corresponding to “image ID”, “generation date and time (photographing date and time)”, and “face image information”. In an entry corresponding to a certain still image, the “image ID” field indicates identification information unique to that still image. The “generation date and time” field indicates a date and time of generation (photographing) of that still image. The “generation date and time” field uses, for example, information appended to that still image data. The “face image information” field includes, for example, a face image (for example, a storage location of data corresponding to a face image), person ID, position, size, degree of smile, degree of sharpness, and degree of full face. Note that when a still image 51 includes a plurality of face images, the index information database table 902 includes pieces of face image information respectively corresponding to the plurality of face images. Also, the index information database table 902 may include information indicating a location of generation of each still image.

The aforementioned database tables shown in FIGS. 7, 8, and 9 are stored in the corresponding databases in the HDD 109. Therefore, the user can edit these databases using the electronic apparatus 10. Furthermore, for example, the control module 602 not only may instruct the transmission processing module 616 to read a moving image saved in advance in the moving image database 630 and to transmit the read moving image to another user terminal, but also may instruct the transmission processing module 616 to read group data from the group database 622 and to transmit the readout group data to another user terminal. Thus, the other user who receives the group data can set the group data without inputting the group data by himself or herself.

The processing sequence from registration of a new user until registration of an anniversary of a group including that new user will be described below with reference to FIG. 10. FIG. 10 is a flowchart showing an example of anniversary setting processing of the user terminal of user A according to this embodiment.

This embodiment will explain a case in which a new user is user B.

In block 1000, for example, user B starts registration of user B himself or herself as a new user using his or her user terminal (PC 308). In block 1002, user B inputs, for example, the anniversary information 320 as his or her user information using an input interface such as the keyboard 13 of the PC 308. The anniversary information 320 includes an ID of user B, an anniversary related to user B and a type of that date, and a key image related to user B, as described above.

In block 1004, user registration information such as the anniversary information (that of user B) input by user B in block 1002 is processed. More specifically, for example, the PC 308 transmits the anniversary information of user B to the server 502. The anniversary information of user B is stored in the database in the server 502.

In block 1006, the user terminal of user A executes setting processing of a group including users A and B. For example, a group including users A and B is set using the user IDs of users B and A. In block 1008, anniversary setting processing is executed. In block 1006, the user terminal of user A receives the anniversary information of user B from the user terminal of user B. In this case, the user terminal of user A may receive the anniversary information of user B from the user terminal of user B via the server 502 by transmission the anniversary information request 514 including the user ID of user B to the server 502. A case will be assumed wherein the anniversary information of user B has already been registered in the server 502. In this case, the user terminal of user A can receive the anniversary information of user B from the server 502 by transmission the anniversary information request 514 including the user ID of user B to the server 502. Of course, the user terminal of user A may receive the anniversary information of user B from the user terminal of user B by directly communicating with the user terminal of user B.

In block 1008, user A may edit the anniversary information of user B based on the anniversary information received from the user terminal of user B. Alternatively, user A may add information associated with the anniversary related to user B. Furthermore, in block 1008, the anniversary related to the group set in block 1006 is also set. Items to be set include, for example, a group name and a key image related to the group. In block 1010, the aforementioned processing ends.

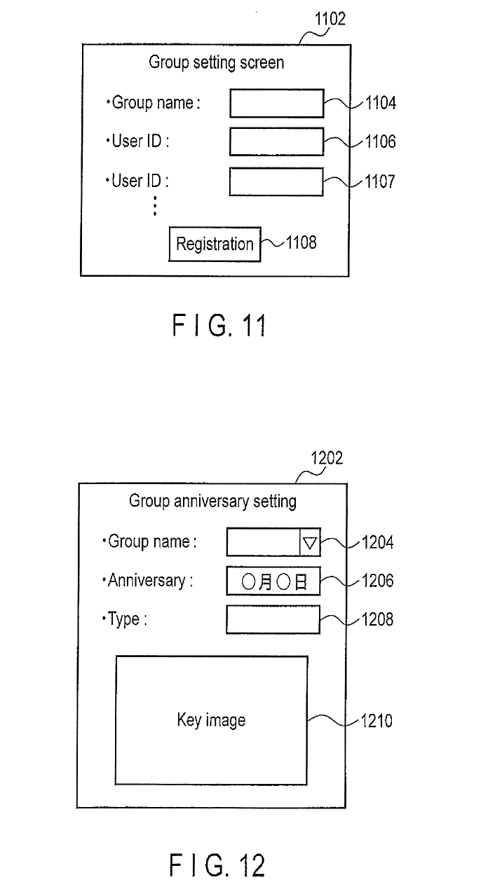

Setting screens related to a group will be described below with reference to FIGS. 11, 12, and 13. FIGS. 11, 12, and 13 show setting screens required to execute the processes corresponding to blocks 1006 and 1008 shown in FIG. 10.

FIG. 11 shows an example of a group setting screen displayed by the photomovie generation application program 202 in the process in block 1006 of FIG. 10. For example, a group setting screen 1102 includes a group name input area 1104, user ID input area 1106, user ID input area 1107, and registration button 1108. The group name input area 1104 is that which allows the user to input the aforementioned group name. The user ID input areas 1106 and 1107 are those which allow the user to input user IDs of users to be members of the group. After the aforementioned items are input, the user clicks the registration button 1108 by operating an input device such as the touch pad 16. The photomovie generation application program 202 registers data associated with a new group in the group database table 702 based on the information of the respective items input on the group setting screen 1102. Thus, the photomovie generation application program 202 sets the new group.

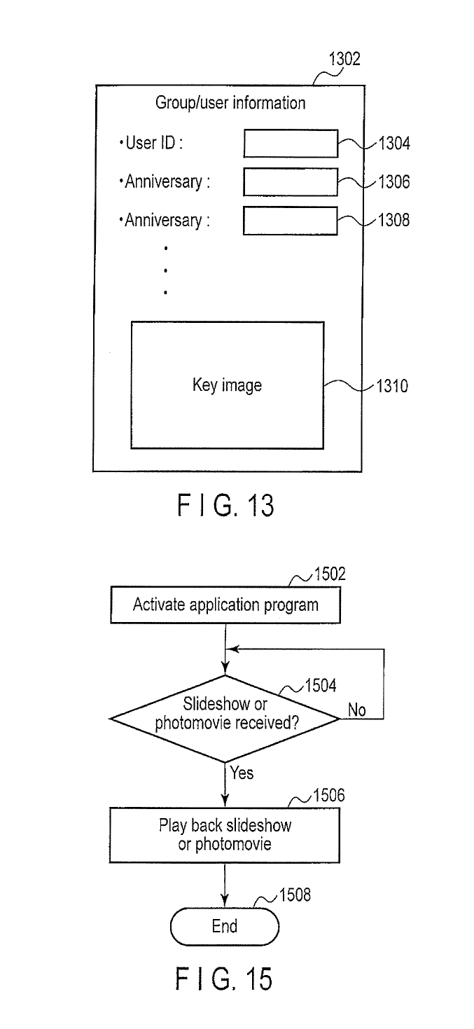

Note that since the group includes a plurality of users, the group setting screen 1102 is configured to allow to register a plurality of user IDs. Instead, for example, the user may input only one user ID, and may click the registration button 1108 to register a group. In such case, the user can register additional user IDs upon editing of group setting information to be described later with reference to FIG. 13. Also, in the user ID input areas 1106 and 1107, for example, information unique to each user (for example, a user name unique to each user or an IP address of that user) may be input.

FIGS. 12 and 13 show examples of a group anniversary setting screen and group/user information edit screen displayed by the photomovie generation application program 202 in the process in block 1008 of FIG. 10.

As shown in FIG. 12, a group anniversary setting screen 1202 includes a group name input area 1204, anniversary input area 1206, type input area 1208, and key image display area 1210. The group name input area 1204 is that which allows the user to input a group name for which an anniversary is to be set, or to select a group name for which an anniversary is to be set from a plurality of already set group names. For example, a case will be assumed wherein a plurality of groups (for example, “group 1” and “group 2”) have already been registered using the group setting screen shown in FIG. 11. In this case, the user can select “group 1” or “group 2” by operating a pull-down menu of the group name input area 1204 shown in FIG. 12. Note that since information input to the group name input area 1204 need only specify a target group, for example, an ID unique to a group may be used in place of the group name. The anniversary input area 1206 is that which allows the user to input a date of an anniversary related to the group having the group name input to the group name input area 1204. The type input area 1208 is that which allows the user to input a type of the anniversary input to the anniversary input area 1206. The key image display area 1210 displays a key image to be associated with the group having the group name input to the group name input area 1204. For example, the user may select a photograph related to the group from a plurality of still images included in the HDD 109. In this case, that selected photograph is displayed on the key image display area 1210.

The photomovie generation application program 202 registers data associated with an anniversary of a group in the anniversary database table 802 based on information of the respective items input to the group anniversary setting screen 1202. Thus, the photomovie generation application program 202 sets the anniversary of the group and the type of that anniversary, and associates the key image with that group.

Note that the group anniversary setting screen 1202 allows the user to input an anniversary in the area 1206 using the pull-down menu of the group name input area 1204 as shown in FIG. 12, thus setting the anniversary of each group. Instead, when, for example, a group name is specified from a key image displayed on the area 1210 without displaying any group name input area 1204, the group name input area 1204 may not be displayed on the group anniversary setting screen 1202.

FIG. 13 shows an example of a group/user information edit screen 1302. The group/user information edit screen 1302 shown in FIG. 13 allows the user to edit information related to a group or that related to an anniversary of the group set on the group setting screen 1102 and group anniversary setting screen 1202 described above with reference to FIGS. 11 and 12. Note that the group/user information edit screen 1302 also allows the user to edit information related to a user in addition to that related to the group. In this case, “edit” means to rewrite already set data and to add new information. More specifically, a case will be assumed wherein the user inputs a certain user ID in a user ID input field 1304 on the group/user information edit screen 1302. In this case, anniversaries corresponding to a user specified by the input user ID are respectively displayed in anniversary input areas 1306, 1308, . . . . Furthermore, a key image related to the user specified by the input user ID is displayed on a key image display area 1310. The user can make edit operations, that is, he or she can add or change an anniversary, can add or change a key image, and so forth.

The setting screens of a group or user and an anniversary of the group or user have been described with reference to FIGS. 11, 12, and 13. Since the respective setting screens are displayed on the LCD 17 of the electronic apparatus 10 in this manner, the user inputs information according to the displayed screens, thus easily registering or editing information of the group or user.

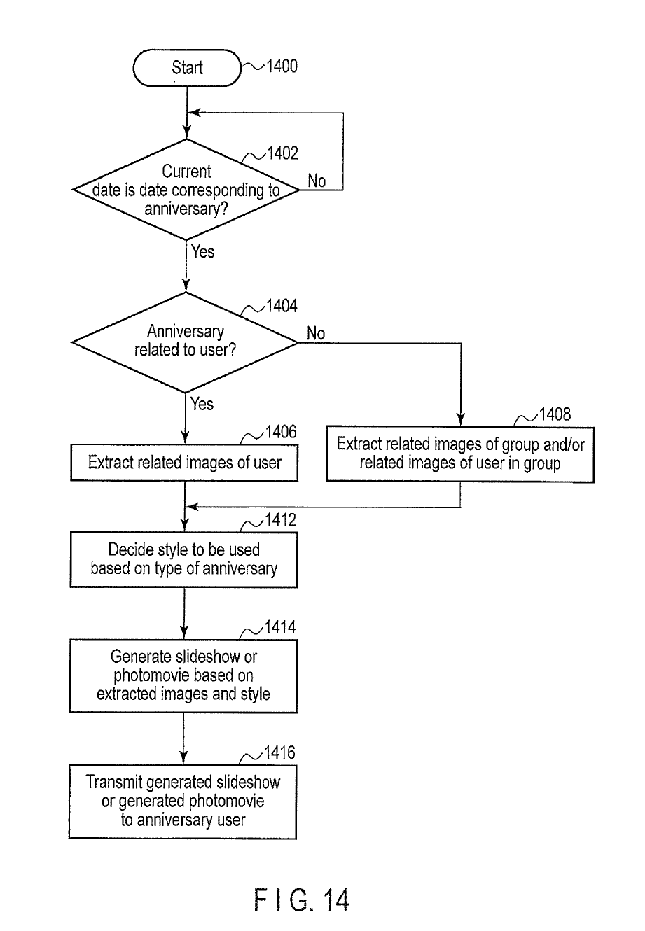

The sequence of the moving image data generation processing executed by the photomovie generation application program 202 will be described below with reference to the flowchart shown in FIG. 14.

In block 1400, the electronic apparatus 10 or photomovie generation application program 202 is activated. Simultaneously with activation of the electronic apparatus 10, the photomovie generation application program 202 may be activated.

The date determination module 604 determines in block 1402 whether or not the date is the date corresponding to an anniversary of a user or group stored in the anniversary database 624. More specifically, the date determination module 604 acquires the current date from the RTC 140A, and determines whether or not that current date corresponds to an anniversary of a user or group stored in the anniversary database 624. If the current date does not correspond to any anniversary, the photomovie generation application program 202 waits until the current date reaches a date corresponding to an anniversary. If the current date corresponds to an anniversary, the process advances to block 1404.

The photomovie generation application program 202 determines in block 1404 whether the anniversary corresponding to the current date determined in block 1402 is that of a certain user or a certain group. If the anniversary corresponding to the current date is that of a certain user, the process advances to block 1406; if the anniversary corresponding to the current date is that of a certain group, the process advances to block 1408.

In block 1406, the image extraction module 613 specifies a user ID of a user who has the anniversary corresponding to the current date, that is, a user who celebrates the anniversary with reference to the anniversary database table 802. Then, the image extraction module 613 specifies a key image associated with that user ID. Next, the image extraction module 613 extracts still images related to the specified key image from those in the content database 628. For example, still images, in which persons of the same face images in the key image appear, and the like are extracted.

In block 1412, the slideshow/photomovie generation module 612 decides a style used to generate moving image data based on a type of the anniversary. For example, eight different styles (Happy, Fantastic, Ceremonial, Cool, Travel, Party, Gallery, and Biography) are prepared in advance. For example, when the anniversary is a birthday, and the type of the anniversary is “Happy”, for example, the style “Happy” of the eight different styles can be used. Note that the style to be used may be automatically decided based on features (for example, the degree of smile, degree of sharpness, degree of full face, and the like of a detected face image) of each of still images extracted by the face image detection module 611.

In block 1414, the slideshow/photomovie generation module 612 generates a slideshow or photomovie based on the still images extracted in block 1406 and the style decided in block 1412. The generated slideshow or photomovie may be stored in the moving image database 630 as a moving image data file of a predetermined video format.

When the slideshow/photomovie generation module 612 generates a photomovie, it selects a scenario, that is, it selects one of a plurality of pieces of scenario information prepared in advance in accordance with the selected style, feature values of the extracted still images, and the like. Each scenario information specifies an order of effects (effect sequence) and attributes of still images (still image attributes), which are to be used in a plurality of chapters (scenes) in a sequence of a photomovie. For example, assume that when a sequence of a photomovie includes five chapters (chapters 1, 2, 3, 4, and 5), chapter 1 is an opening scene of the photomovie, and chapter 5 is an ending scene of the photomovie. For each chapter, one or more effects are defined, and still image attributes are also defined for respective effects.

As the still image attributes, for example, person attributes (face attributes) may be used. As the person attributes, for example, a person corresponding to a key image, another person related to the key image, a degree of smile, a degree of sharpness, the number of persons who appear in the image, and the like can be used. For example, a person (face) who has a high co-occurrence frequency with the person corresponding to the key image may be decided as another person related to the key image. The person attribute can designate other persons related to a plurality of key images. A plurality of persons (faces) having high co-occurrence frequencies with the person corresponding to the key image can be other persons related to the key image. As the still image attributes, for example, location attributes may be used in addition to the person attributes. The location attributes designate photographing locations of still images to be used.

In block 1416, the transmission processing module 616 transmits the moving image data (slideshow or photomovie) generated in block 1414 to the user terminal of the user who celebrates the anniversary.

Note that the slideshow or photomovie may be generated further using the key image related to the user having the anniversary in block 1414. For example, the key image related to the user is further added to the still images extracted in block 1406. Thus, the slideshow or photomovie including the key image related to the user is generated in block 1414. Likewise, for example, when the user having the anniversary belongs to a predetermined group, a key image of that group may be further added to the still images extracted in block 1406. Thus, the slideshow or photomovie including the key image related to the user and that of the group to which the user belongs is generated in block 1414. Furthermore, for example, still images related to the group may be extracted in block 1406 based on the key image of the group to which the user belongs. The extracted still images related to the group to which the user belongs are added to the still images related to the user extracted in block 1406 together with the key image related to the user and that of the group to which the user belongs. Then, the slideshow or photomovie which includes the key image related to the user, that of the group to which the user belongs, and the still images related to the group to which the user belongs is generated in block 1414.

The generation processing of the moving image data on the anniversary related to the user has been described with reference to FIG. 14. The generation processing of moving image data on an anniversary related to a group other than the user will be described below with reference to FIG. 14 again.

If it is determined in block 1404 in FIG. 14 that the current date is not an anniversary related to a user, that is, the current date is an anniversary of a group, the process advances to block 1408.

In block 1408, the image extraction module 613 extracts still images related to the group which celebrates the anniversary from a plurality of still images stored in the content database 628 based on a key image related to that group.

Next, the process advances to block 1412 to decide a style to be used based on the type of the anniversary of the group as in the aforementioned generation sequence of the moving image data of the anniversary related to the user.

In block 1414, the slideshow/photomovie generation module 612 generates a slideshow or photomovie based on the still images extracted in block 1408 and the style decided in block 1412. Since details of the generation processing of the slideshow or photomovie are the same as those of the aforementioned generation sequence of the moving image data of the anniversary related to the user, a description thereof will not be repeated.

In block 1416, the slideshow or photomovie generated in block 1414 is transmitted to respective users included in the group which celebrates the anniversary. Note that the slideshow or photomovie may be transmitted to all users included in the group having the anniversary or may be transmitted to, for example, some of a plurality of users included in the group.

Note that the key image related to the group having the anniversary is added in block 1414 to the still images related to the group extracted in block 1408. Thus, the slideshow or photomovie including the key image related to the group having the anniversary is generated. Furthermore, key images related to users included in the group having the anniversary are added to the still images related to the group extracted in block 1408. Thus, the slideshow or photomovie including the key image related to the group having the anniversary and those related to the users included in the group having the anniversary is generated.

Also, in block 1408, still images related to the users included in the group having the anniversary are extracted by the same method as the extraction method of the still images related to the group. The extracted still images related to the users are added to the still images related to the group extracted in block 1408 together with the key image related to the group having the anniversary and those related to the users included in the group having the anniversary. Thus, the slideshow or photomovie including the key image related to the group having the anniversary, those related to the users included in the group having the anniversary, and the still images related to the users included in the group having the anniversary is generated.

According to the embodiment, the photomovie generation application program 202 executes the moving image data generation processing. With this processing, even when a user who wishes to transmit moving image data forgets a date of an anniversary of each individual user or that of a group, the photomovie generation application program 202 can automatically generate a moving image, and can transmit the moving image to the user related to the anniversary. Furthermore, if moving image data related to the group and users in that group is generated, each user who received the generated moving image data can browse the moving image data which includes not only images related to the group but also images which are related to the users in the group and have not ever been browsed by the receiving user. Therefore, the user who received the moving image data has more fun.

Finally, the processing sequence associated with reception of the moving image data generated by the moving image data generation processing sequence described with reference to FIG. 14 will be described below with reference to FIG. 15. FIG. 15 is a flowchart showing an example of the sequence from reception processing until playback processing of moving image data executed by the electronic apparatus 10 according to this embodiment.

In block 1502, the photomovie generation application program 202 is activated to start reception processing of moving image data. The photomovie generation application program 202 may be activated simultaneously with activation of the electronic apparatus 10.

The photomovie generation application program 202 determines in block 1504 whether or not a slideshow or photomovie has been received. The slideshow or photomovie is transmitted from, for example, the user terminal of a user in the group or the user terminal which registers the anniversary. If a slideshow or photomovie has not been received, the photomovie generation application program 202 waits in that state. If a slideshow or photomovie has been received, the process advances to block 1506.

In block 1506, the moving image playback module 614 of the photomovie generation application program 202 plays back the slideshow or photomovie received by the reception processing module 618. Note that when the reception processing module 618 receives the slideshow or photomovie, the moving image playback module 614 may automatically play back that slideshow or photomovie. For example, the control module 602 may instruct the moving image playback module 614 to play back moving image data received by the reception processing module 619 based on a user's instruction.

Upon completion of playback of the moving image data, the moving image data reception processing also ends in block 1508.

Note that the photomovie generation application programs 202 installed in the user terminal which transmits moving image data and that which receives the moving image data may be the same programs, but they need only have similar functions. The similar functions include, for example, a function of generating moving image data based on anniversary information transmitted from another user, a function of automatically playing back moving image data upon reception of the moving image data, and the like. Furthermore, since the received moving image data is stored in the moving image database 630 in the HDD 109, the moving image data can be played back again after that moving image data is received and played back. Also, the moving image data stored in the moving image database 630 may be played back by a moving image playback application other than the photomovie generation application program 202.

Since all the processing sequences described in this embodiment can be implemented by software, by only installing and executing programs, which implement these processing sequences in a ordinal computer via a computer-readable storage medium storing these programs, the same effects as in this embodiment can be easily attained.

The functions of the respective modules shown in FIG. 6 may be implemented by, for example, hardware such as a dedicated LSI and DSP.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For example, though the anniversary is set and the moving image is generated based on the anniversary, a generation timing is not limited to the anniversary. It is possible to set a particular date (or time period) or predetermined date (or time period) instead of the anniversary and generate the moving image on the particular date (or time period) or predetermined date (or time period).

What is claimed is:

1. An electronic apparatus comprising:
a receiving module configured to receive, from a user terminal via a network, date information which indicates a particular date of a user of the user terminal and includes a first image related to the user of the user terminal;
a moving image generation module configured to extract a first still image group related to the first image in the date information from a plurality of still images, and to generate a first moving image using the extracted first still image group;
a clock module configured to measure a date; and
a transmission module configured to transmit the first moving image to the user terminal via the network when the date indicated by the clock module is a date corresponding to the particular date of the user of the user terminal.

2. The apparatus of claim 1, wherein the particular date comprises an anniversary.

3. The apparatus of claim 1, wherein the user terminal comprises terminal devices corresponding to a plurality of users and
wherein the receiving module is configured to receive date information from the terminal devices via the network.

4. The apparatus of claim 1, further comprising:
a group setting module configured to set a user group including a plurality of users, and to associate a second image with the user group; and
a date setting module configured to set a particular date of the user group,
wherein the moving image generation module is further configured to extract a second still image group related to the second image from the plurality of still images, and to generate a second moving image using the extracted second still image group, and
when the date indicated by the clock module is the date corresponding to the particular date of the user group, the transmission module is configured to transmit the second moving image to user terminals of the plurality of users who belong to the user group via the network.

5. The apparatus of claim 4, further comprising:
a data receiving module configured to receive the second moving image from the user terminal of a user who belongs to the user group via the network; and
a playback module configured to play back the received moving image.

6. The apparatus of claim 1,
wherein the date information comprises information indicating a type of the particular date of the user of the user terminal, and
wherein the moving image generation module is configured to generate the first moving image based on the type of the particular date.

7. An image processing method comprising:
receiving, from a user terminal via a network, date information which indicates a particular date of a user of the user terminal and includes a first image related to the user of the user terminal;
extracting a still image group related to the first image in the date information from a plurality of still images, and generating a first moving image using the extracted still image group; and
transmitting the first moving image to the user terminal via the network when the date indicated by a clock module is a date corresponding to the particular date of the user of the user terminal.

8. The method of claim 7, wherein the particular date comprises an anniversary.

9. A computer-readable, non-transitory storage medium having stored thereon a computer program which is executable by a computer, the computer program controlling the computer to execute functions of:
receiving, from a user terminal via a network, date information which indicates a particular date of a user of the user terminal and includes a first image related to the user of the user terminal;
extracting a still image group related to the first image in the date information from a plurality of still images, and generating a first moving image using the extracted still image group; and
transmitting the first moving image to the user terminal via the network when the date indicated by a clock module in the computer is a date corresponding to the particular date of the user of the user terminal.

10. The program of claim 9, wherein the particular date comprises an anniversary.
